(19) United States
(12) Patent Application Publication
(10) Pub. No.: US 2010/0140039 A1
(43) Pub. Date: Jun. 10, 2010

(54) Pump Clutch

(76) Inventors: Ezatolah Dayanifar, Tehran (IR); Mohammad Hassan Mahdjoubi, Nicosia (CY)

Correspondence Address: CHOBIN & CHOBIN CONSULTANCY L.L.C, Green Community, Building 3, Ground Floor, Dubai Investment Park, P.O Box 212880, Dubai, AE

(21) Appl. No.: 12/327,821

(22) Filed: Dec. 4, 2008

(51) Int. Cl. F16D 31/04

(52) U.S. Cl. 192/58.7

(57) ABSTRACT

The pump clutch is a device which transfers energy from its input shaft to the output shaft where a hydraulic gear pump is provided to enable the circulation of oil inside. The clutch input shaft is connected to the pressure production system; thus, the energy it requires to circulate the oil is provided. The amount of engagement between the clutch output shaft and the clutch input shaft is determined by the amount of oil circulating in the system. In turn, the amount of oil in the device is controlled by the control tap. With the clutch output shaft stabilized on the surface, we can control the circulation of the oil in the system with the control tap and the energy in the input shaft is thus transferred onto the stabilized surface through the output shaft thereby halting the rotation of the input shaft.

### FILED OF THE INVENTION

The present invention relates to a mechanism with at least two clutch-assemblages associated together to transmit rotation from at least one rotating input shaft to at least one rotatable output shaft.

### BACKGROUND OF THE INVENTION

A clutch is a mechanical device which functions to mechanically engage and disengage the engine and the gearbox. Current clutches connect and disconnect the engine from the gearbox by increasing and decreasing friction between two discs; one of which is attached to the engine while the other is attached to the gearbox. Therefore, it would be advantageous to introduce a device that either reduces the friction or/and eliminates substantially the friction between the input shaft and output shaft. The present invention has been designed in such a way that there is no mechanical contact whatsoever between input shaft and output shaft, whereas contact is with the use of a liquid when there is engagement between the clutch input shaft and the clutch output shaft; thus, no wear and tear would occur.

### SUMMARY OF THE INVENTION

An objective of the present invention is to provide a mechanical device to engage and disengage an engine and a gearbox.

Yet another object of the present invention is to provide a system for engaging an input shaft and an output shaft by means of circulation of a liquid substance.

Yet another object of the present invention is to provide a pump clutch to transfer substances from one place to another. For instance, the pump clutch facilitates the flow of oil into the inside through an entrance chamber and with the use of pressure exits through an exit chamber. Pump clutch are able to do this through various ways; as examples, by the backward and forward motion of a piston inside a cylinder, through the rotation of one interior rotor inside an exterior rotor, or having vanes (blades) rotate to operate the pump clutch.

Yet another object of the present invention is to provide a pump clutch, wherein the pump clutch transfers a predetermined amount of a substance from one place to another by creating friction between the clutch entrance shaft and the clutch output shaft. In this particular system, any of the different pumps mentioned above can be utilized.

Yet another object of the present invention is to provide a system for reducing wear and tear when engaging an input shaft and an output shaft.

Yet another object of the present invention is to provide a method and system for transferring energy from an input shaft to an output shaft.

Yet another object of the present invention is to provide a system and method for stopping or reducing a transfer of energy from an input shaft to an output shaft.

### DESCRIPTION OF THE DRAWINGS

Referring now to the attached drawings which form a part of this original disclosure:

FIG. 1 is a perspective view of an assembled Pump Clutch (1).

FIG. 2 is a perspective view of a cross-section of a Pump Clutch (1) showing the interior parts in their respective positions.

FIG. 3 is an exploded view of the input shaft (2), the pump interior rotor (6), and the dents (23). In this view is shown the order of each part pertinent to its location with other parts.

FIG. 4-A is a view of an assembled input shaft (2).

FIG. 4-B is a front view of the interior rotor (6) which shows the location of indention number 10 to which elongated part number 24 located on the input shaft (2) is put in place. Also shown is indention number 11 to which the teeth (23) of the interior rotor (6) located on the input shaft (2) is locked to prevent unwanted spinning.

FIG. 4-C is a front view of the input shaft which shows the location of indention number 22 to which the teeth (23) are locked in.

FIG. 5 is an exploded view of the hydraulic gear pump (5) showing all of the parts in its order of assembly and their pertinent location such as the pump casing (12), the exterior rotor (7), the interior rotor (6), the input shaft (2), and the teeth (23).

FIG. 6-A is a perspective view of an assembled hydraulic gear pump which shows the axle of the small gear (8) and the axle of the large gear (9) as indicated with dash and dotted lines.

FIG. 6-B is a perspective rear view of the pump casing (12) which shows a smooth hole (27) to which is to be attached the input shaft (2).

FIG. 6-C is a front view of the hydraulic gear pump showing the parts of the pressure production system including the interior rotor (6), exterior rotor (7), and their location inside the pump casing (12); moreover, the figure illustrates the presence of hydraulic oil (4).

FIG. 7 is a perspective and exploded view of the control tap (17) showing the sequential order of the parts when assembled; parts include the tap casing (32), the lid casing (3), and the piston (33).

FIG. 8-A is a perspective view of a cross section of the tap casing (32). In this view can be seen the transfer tubes (18 & 19), the ventilation vent (34), the pump's entrance chamber (15) as well as other parts.

FIG. 8-B is a perspective cross-section view of the tap casing (32) showing the direction of the position of transfer tube number 18 on the casing.

FIG. 9-A is a perspective view of the tap casing (32).

FIG. 9-B is a top cross-section view of the tap casing which shows the position of the transfer tubes (18 & 19), the entrance chamber (15), and the exit chamber (16).

FIG. 9-C is a perspective view of the tap casing (32) such that the transfer tubes (18 & 19) and the exit chamber are shown.

FIG. 10 is a perspective view of the base of the pump clutch (47) showing the location of a hole (48) which function to lock in the input shaft (2) and another hole (49) which function to lock in the output shaft (3) thereby fixing the pump clutch in place.

FIG. 11-A is a top cross-section view of the pump clutch showing the tap control in an open state; thus, the piston (33) is also open thereby allowing the oil to circulate from the pump's exit chamber (14) to enter transfer tube number 18 and through the tap entrance chamber (15) enter the tap exit chamber then on to the pump's entrance chamber (13) through transfer tube number 19. In such a condition, the input shaft (2) and the output shaft (3) are not in contact with each other.

FIG. 11-B is a top cross-section view of the pump clutch showing the tap control in a close state; thus, the piston (33) is also closed. In such a condition, oil cannot circulate in the system and the input and output shafts are in contact with each other.

FIG. 12-A is a schematic view of the pump clutch system showing the position of the tap control out of the center in an open state; thus, oil is allowed to flow from the pump's exit chamber (14) through transfer tube number 18 into the tap entrance chamber (15), then to the tap exit chamber, and through transfer tube number 19 enter pump's entrance chamber (13). In this condition, the input shaft (2) and the output shaft (3) are not in contact with each other.

FIG. 12-B is a schematic view of the pump clutch system showing the position of the tap control out of the center in a close state; thus, oil cannot circulate inside the system. In such a condition, the input shaft 92) and the output shaft (3) are in contact with each other.

### DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

The preferred embodiment and other embodiments of a pump clutch according to the invention will now be described with reference to drawings wherein like numerals refer to like parts.

In the preferred embodiment is provided a pump clutch (1) for transferring energy from an input shaft to an output shaft, wherein said pump clutch comprises:

an input shaft (2); and an output shaft wherein said output shaft comprises of a hydraulic pump (5) and a control tap (17) wherein said control tap comprises of tap casing (32) and a piston (33), wherein said hydraulic pump comprises of a case (12) and a means for producing pressure (25), wherein said means for producing pressure circulates a predetermined amount of oil within said output shaft, and wherein said input shaft is connected to said means for producing pressure (25), and wherein said input shaft turns said means for producing pressure, and wherein said control tap controls said predetermined amount of oil circulating within said output shaft, and wherein said predetermined amount of circulating oil determines amount of transferring energy from said input shaft to said output shaft.

In another embodiment said hydraulic pump case rotates in accordance to rotations of said input shaft.

In another embodiment said output shaft further comprises: an entrance chamber (13); an exit chamber (14); a tap entrance chamber (15); a tap exit chamber (16); a first transfer tube (18), a second transfer tube (19) and a third transfer tube (36), wherein said first transfer tube (18) connects said exit chamber (14) to said tap entrance chamber (15) and wherein said second transfer tube (19) and third transfer tube (36) connect said tap entrance chamber (15) to said entrance chamber (13);

Means for opening said control tap to allow circulation of oil through said entrance chamber (13) onto said exit chamber (14); means for transferring energy received by said input shaft from said source of energy to said output shaft by closing said control tap to prevent circulation of said oil between said entrance chamber (13) onto said exit chamber (14).

In another embodiment said control tap (17) is situated between said entrance chamber (13) and said exit chamber (14).

In another embodiment said control tap is a part of said output shaft and rotates according to rotation of said output shaft.

In another embodiment said control tap is in a fix position and is detached from said output shaft.

In another embodiment said output shaft is fixed to a fixed base surface and said source of energy applied to said input shaft is transferred to said fixed base surface.

In another embodiment said energy transferred to said fixed base surface is controlled by said control tap.

In another embodiment said input shaft and said output shaft are interchangeable.

In another embodiment is provided a method for transferring energy, from an input shaft to an output shaft, wherein said method comprises steps of:
Receiving a predetermined amount of energy from a source of energy by said input shaft;
Circulating a predetermined amount of a substance within said output shaft;
Controlling said circulating within said output shaft; and
Obtaining a transferred energy amount from said input shaft to said output shaft.

In another embodiment is provided, producing a pressure by a hydraulic gear pump wherein said hydraulic gear pump comprises of an interior rotor (6), and a exterior rotor (7), and wherein said interior rotor and said exterior rotor are engaged in way that a predetermined space is created for said substance circulation;

Controlling said circulation by a control tap, wherein said energy received from said source of energy by said input shaft is transferred to said output shaft according to said predetermined amount of substance circulating within said output shaft, and wherein said predetermined amount of circulating substance determines amount of transferring energy from said input shaft to said output shaft.

In another embodiment is provided a pump clutch comprising of: at least two parts, one, the pressure production system and two, the pump clutch casing. The pump clutch pressure production system is made up of a set of parts which functions to pump clutch liquid, requiring energy to do so; and, the energy required is provided through an opening. This opening can be a simple shaft turned by an engine; for instance, an opening in a vane or blade pump clutch is a shaft which is directly attached to the blade. When the entrance shaft turns it causes the blade to turn as well. With a gear pump clutch the flow of energy is through a shaft which is directly attached to the pump clutch's interior rotor (6). The turning of this rotor makes the exterior rotor (7) turn thus facilitating the transfer of oil from the entrance chamber to the exit chamber. Moreover, all pumps need a casing which is stable in one position. The pump pressure production system makes use of the pump casing (12) to exert pressure on the oil thus allowing it to flow out from the exit chamber. In all pumps, the pump casing acts as a stabilizer; and for this, the casing must be in a stable position so that the pump pressure production section can exert pressure on the substance with its assistance. But with the pump clutch, the pump casing like the pump pressure production section has the capability of turning until such time that the substance with the pressure provided by the pump flows into the exit chamber; and, from the entrance chamber returns back inside the pump. No energy goes towards the pump casing from the entrance chamber; but, if a control tap is put in place, oil is prevented from flowing between the pump entrance and exit chambers. In such a condition, the pump entrance shaft locks; thus, energy in the shaft must be transferred to other sections and in this case it is transferred to the pump casing and since it has been designed to have the capability to turn on its own axis, it then turns. This causes the clutch output shaft to turn as well since it is directly attached to the casing. In this condition, the energy of the clutch entrance shaft is transferred on to the clutch output shaft by the oil.

In another embodiment, the clutch entrance shaft is attached to the pump pressure production system while the clutch output shaft is attached to the pump casing. However, positions can be changed i.e. the clutch entrance shaft be attached to the pump casing and the clutch output shaft to the pump pressure production system.

In another embodiment the pump's entrance and exit chambers are connected to each other through two tubes so that the substance to be transferred can circulate with ease inside the pump. With the pump pressure production system at work, oil is forced out with pressure from the pump exit chamber and flows back to the pump entrance chamber through the transfer tubes.

In another embodiment the clutch control tap is located in the middle of two transfer tubes to facilitate the flow of oil from the pump exit chamber to the pump entrance chamber; moreover, the tap can control the amount of oil circulating inside the system and or halt its flow completely.

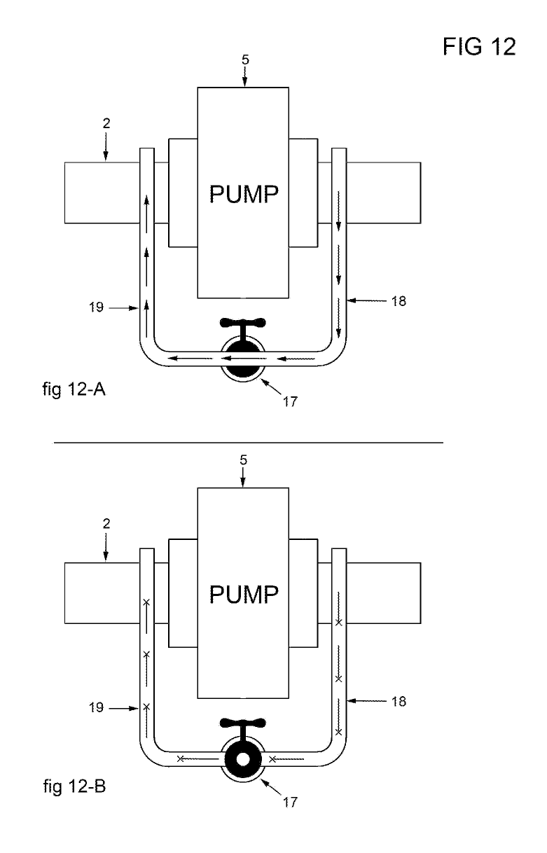

In another embodiment the clutch control tap maybe positioned at the center of the clutch and maybe also be placed outside the whole clutch system. If it is desired to have the clutch tap transferred out of the center of the clutch, the pump exit and entrance chambers must be transferred to it with the use of two tubes and or a hose. Thus, the substance enters the hose from the tap exit chamber and from the pump entrance chamber flow onto the pump. (FIG. 12)

In another embodiment pumps have the ability to circulate all forms of substances whether gas, solid, liquid, or . . . . The system of the pump clutch makes use of hydraulic oil.

In another embodiment in both the clutch system and the brake system the disc and plate mechanism are used; and, since the pump clutch system uses the pump mechanism instead of the disc and plate mechanism therefore it maybe also be used for the brake system. This way, the clutch output shaft (which is the pump casing) may be positioned stationary on the chassis of a car and the clutch entrance shaft attached to the wheel. When the clutch control tap is shut off, the flow of oil within the system is halted; therefore, the entrance shaft is unable to turn. Thus, the wheel gets locked (braked). But with the clutch control tap open, the oil is able to circulate inside the system and the entrance shaft may then turn easily thereby making the wheel free to turn. Likewise, positions may be altered i.e. the entrance shaft be positioned on the chassis of a car while the output shaft be attached to the wheel.

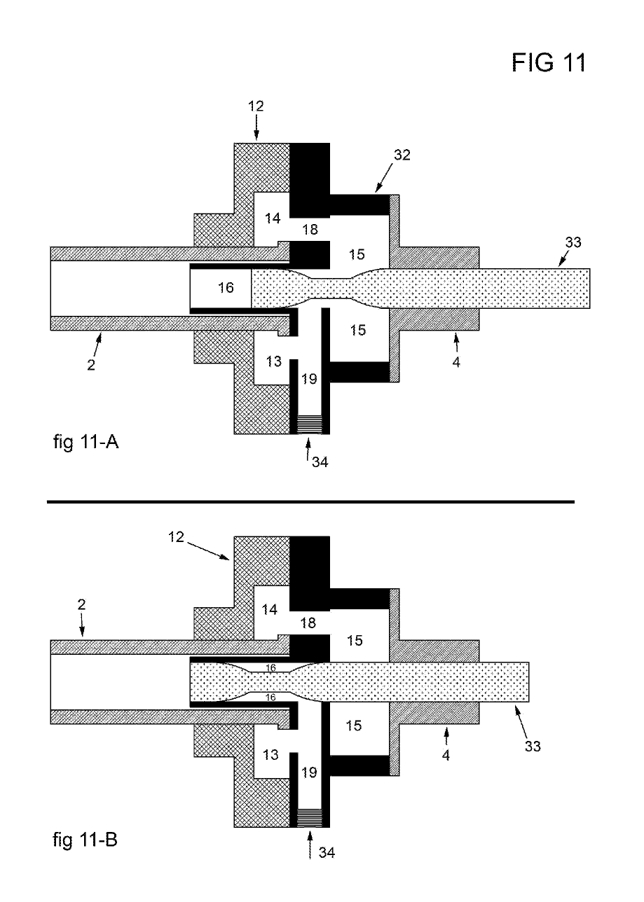

In another embodiment, in the Pump Clutch system, connection between the clutch input shaft (2) and the clutch output shaft (3) is made possible with just oil (25). This design utilizes a hydraulic gear pump (5) to make the clutch input shaft contact with the clutch output shaft. This hydraulic gear pump has one interior rotor (6) and one exterior rotor (7) which are protected by the casing of the pump (12).The entrance chamber of the pump (13) and the exit chamber of the pump (14) are connected to each other by the clutch control tap (17). The connection is made possible through two oil transfer tubes embedded on the pump casing. Transfer tube number (18) connects the pump's exit chamber (14) to the tap's entrance chamber (15) while transfer tube number (19) and a third tube (36) connect the tap's exit chamber (16) to the pump's entrance chamber (13). In such a situation, with the rotation of the clutch input shaft (2), the pump's interior rotor (6) turns thus allowing oil from the pump's exit chamber (14) to enter the tap's entrance chamber (15); and, after it passes the tap's exit chamber (16) through transfer tube (19) and the third tube (36) it again flows back into the pump's entrance chamber. Should the tap be open (FIG. 11-A), oil will easily circulate inside the pump thus making it possible for the clutch input shaft (2) to likewise rotate with ease. At this point, the input shaft and the output shaft are not engaged. On the contrary, should the tap be shut (FIG. 11-B), oil may not circulate inside the pump; so, with the rotation of the clutch input shaft (2) which is dependent on the pump's interior rotor (6), pressure is exerted on the oil thus providing it the capability to exit from the pump's exit chamber (14). However, because the tap (17) is shut off, it does not allow the oil to do so; therefore, the mechanism is forced to find a way to release the pressure. In such a condition, pressure is transferred to the output shaft (3), thereby making it turn. The amount of friction between the clutch input shaft and the clutch exit shaft would depend on the amount of oil circulating in the pump. (FIG. 11 and 12)

Next, the operation of the present embodiments will be described.

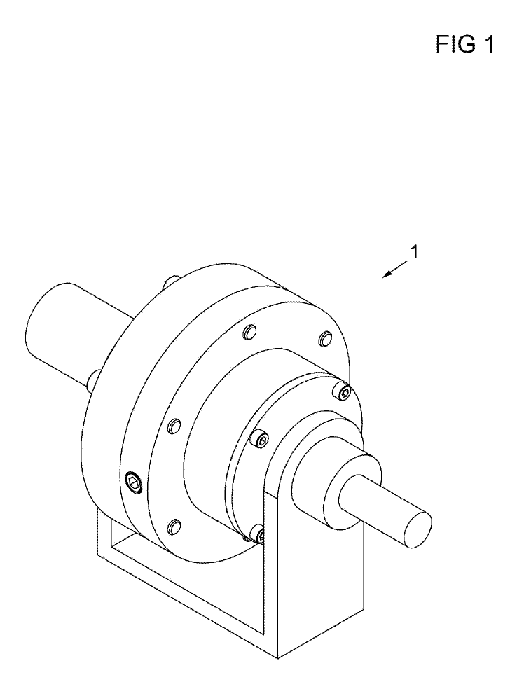

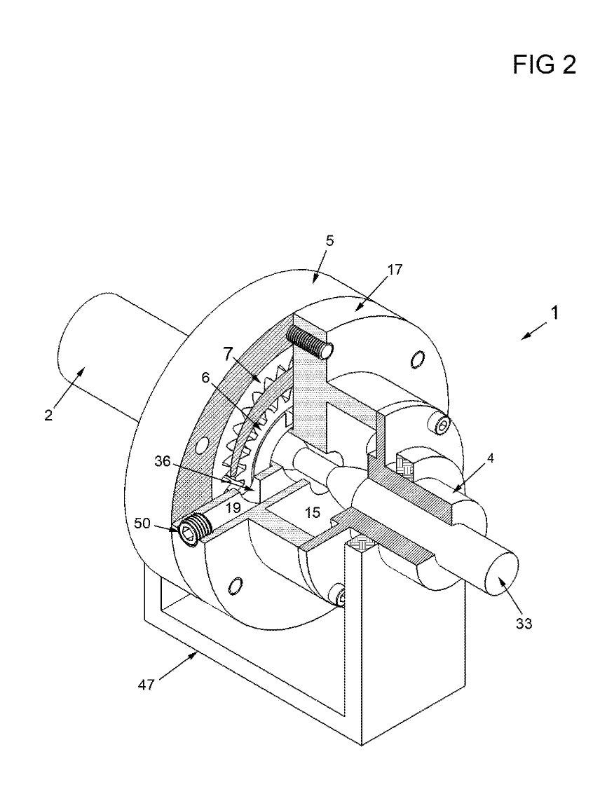

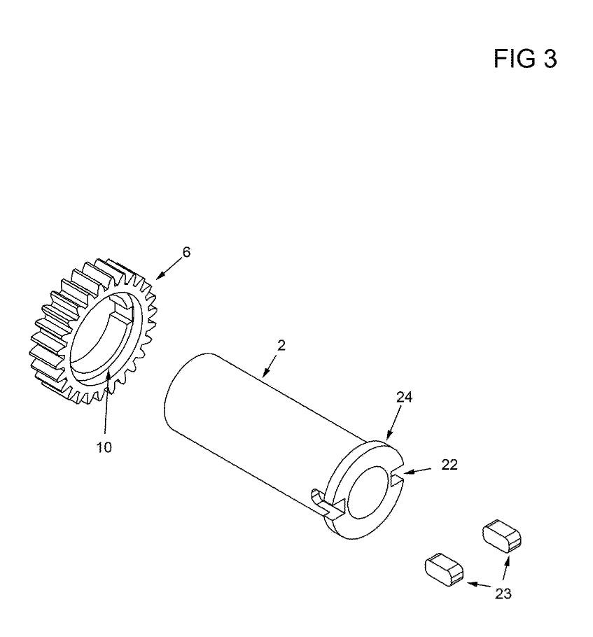

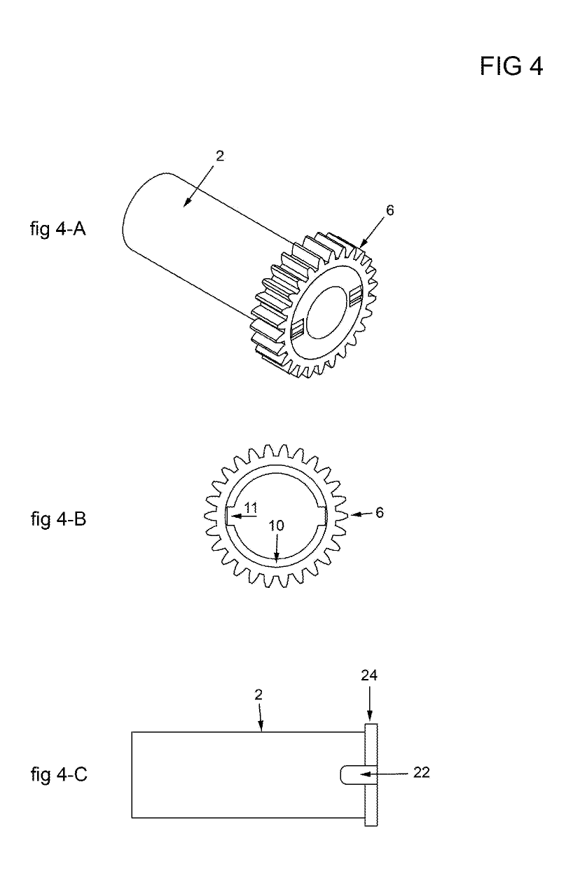

The Pump Clutch is made up of three parts:(FIGS. 1 and 2)
1. Input Shaft (2)
2. Output Shaft (3)
3. Clutch Base (47)
1. Input Shaft (2):(FIGS. 3 and 4) the energy from the engine rotation enters the system through the clutch input shaft; and because the latter is directly attached to the pump's interior rotor, its rotation will likewise cause the turning of the pump's interior rotor. On this clutch input shaft are two dents (22) which serve as slots (22) to which the pump's interior rotor (6) is embedded. Moreover, on its surface is an elevation (24) which prevents the interior rotor (6) from being displaced from the top of the shaft.
2. Output Shaft (3): The clutch output shaft has two parts:
1. Pump of clutch
2. Clutch control tap

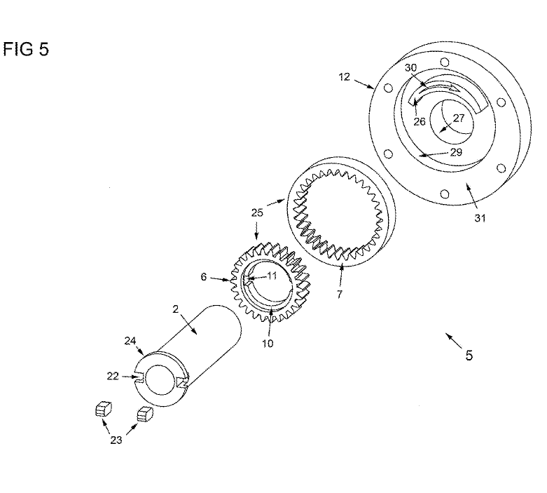

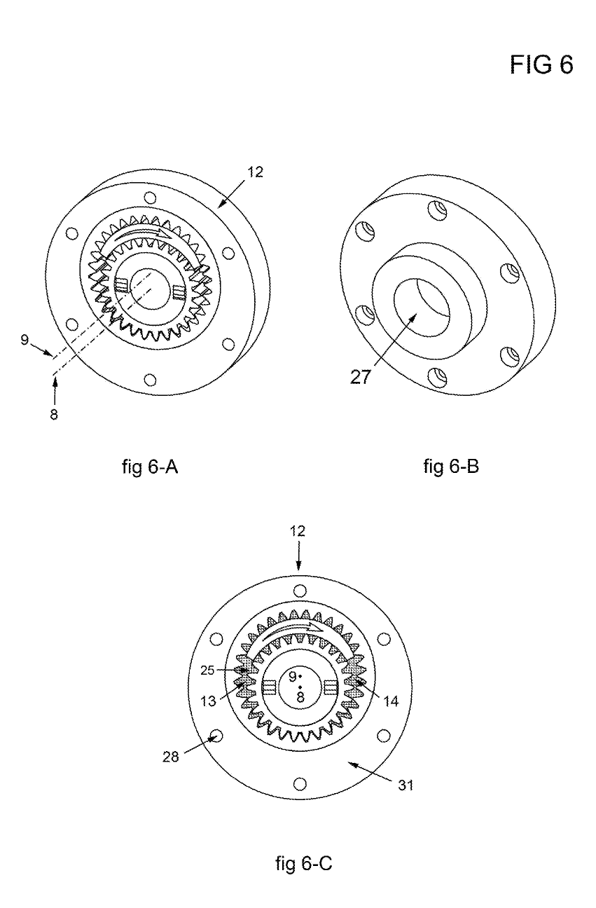

1. Pump of Clutch (5): (FIGS. 5 and 6) the pump of the clutch transfers the energy from the rotation of the clutch input shaft (2) to the oil thereby exerting pressure on it and thus allowing its circulation in the system. This pump is composed of parts which allow oil from the pump's exit chamber (14) to be sent towards the clutch control tap (17) and once it passes the tap through the transfer tube (19) it returns back to the pump's entrance chamber. There are two parts to this pump:
1.1. Pressure Production System
1.2. Pump Casing

1.1. Pressure production system (25): With the Pump Clutch, required pressure may be produced through various methods; for instance, through the action of a piston or with a hydraulic gear pump or other kinds of pump system. In this particular design, the hydraulic gear pump is used. The pressure production system hydraulic gear pump (25) is composed of one small interior rotor, or gear, (6) and one large exterior rotor, or gear, (7) both of which when engaged such that the axle of the small gear (8) and the axle of the large gear are not of one pivot center (FIG. 6-A). The gap between pivot centers of the axles creates two chambers, the entrance chamber (13) and the exit chamber (14) found between the two rotors, or gears. The two chambers are separated from each other by a crescent-shaped divider (26). On the interior rotor is a dent (10) which positions the clutch input shaft on an elevation (24); likewise, on the interior rotor, or gear, are two dents (11) which serve to embed attachment parts (23).

1.2. Pump Casing (12): The pump casing packs the whole pressure production system and protects it. On the casing is a hole (27) to which is entered the clutch input shaft (2). This hole is smooth and with its size ensures that the shaft may easily rotate inside on its axis without oil leaking from the sides; furthermore, there are holes (28) provided which serve to screw down the pump casing to the tap casing. An axle (8) here positions the pump's interior rotor, or gear, and there is also a dent (29) which positions the pump's exterior rotor (7) on the axle (9). Likewise, a crescent-shaped structure (26) between the two rotors serves to divide the entrance (13) and exit (14) chambers located on the pump casing; and, an arrow sign (30) has been cut on it to specify the direction of the rotation of the pump. The surface of the pump casing (31) is smooth and is such that when placed over the surface of the tap casing (41), oil would be prevented from leaking over the sides.

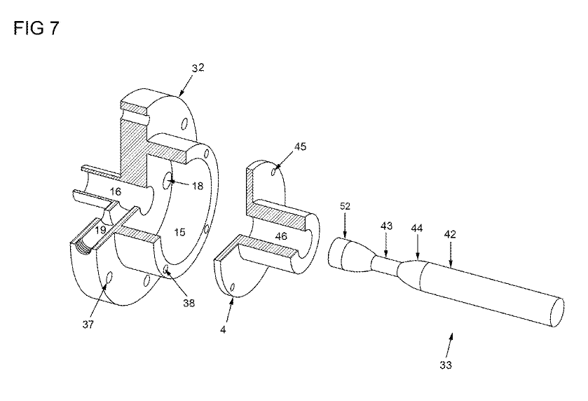

2. Clutch Control Tap (17): (FIGS. 7 and 8 and 9) the tap functions to control the amount of oil circulating in the pump. How easily oil circulates inside the system would mean less engagement between the clutch input shaft (2) and the clutch output shaft (3); and on the contrary, if circulation is poor, engagement between the two clutch shafts would be more.

The tap has three parts:
2.1. Tap Casing (32)
2.2. Lid Casing (4)
2.3. Piston (33)

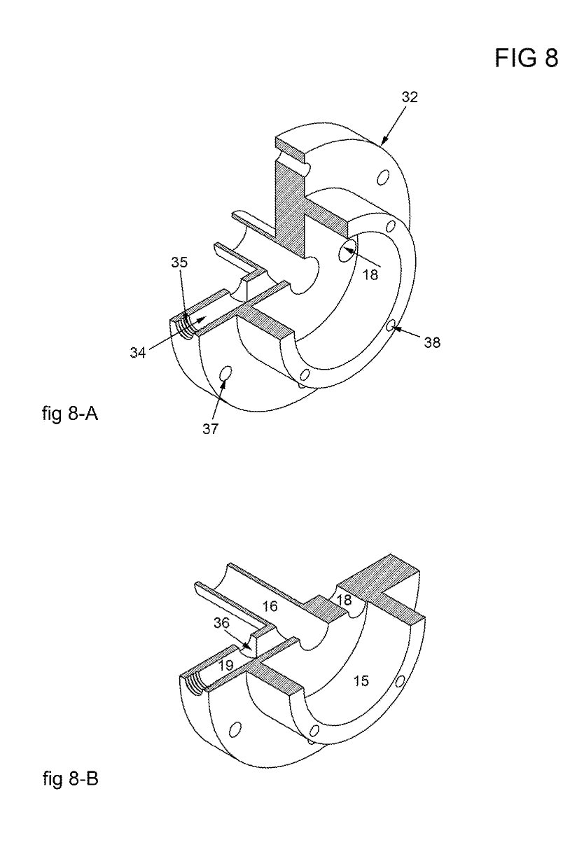

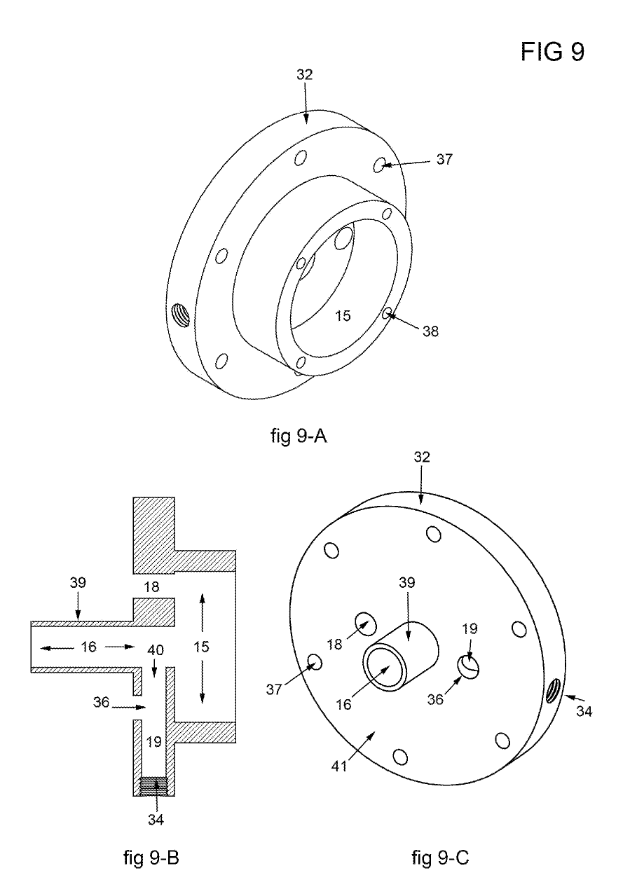

2.1. Tap Casing (33): (FIGS. 8 and 9) The tap casing is a circular disc on which are provided the tap entrance chamber (15) and the tap exit chamber (16). Moreover, on it are two transfer tubes (18) and (19) which are positioned in such a way that one end of transfer tube (18) is attached to the tap entrance chamber (15) while the other end is attached to the pump exit chamber (14); and, as for transfer tube (19), one of its end is attached to the tap exit chamber (16) and the other end to the ventilation vent (34). The opening hole of the pump (36) is located midway of transfer tube (19) and oil flowing from transfer tube (19) enters the pump's opening hole (36) after which it enters the pump's entrance chamber (13). Moreover, the transfer tube ventilation vent (19) is screwed onto nut (35) with the use of screw (50). Transfer tube (19) is also used for filling and emptying oil from the system in addition to ventilating it. Holes (37) position the tap casing (32) to the pump casing; and, an indentation on the casing acts as the tap's entrance chamber (15). Holes (38) on the tap casing serve to screw on the lid casing (4). Also on the casing is a cylinder (39) the central hole of which is the tap's exit chamber (16). Inside this chamber are holes (40) through which oil from transfer tube (19) flows towards the pump's entrance chamber (13). The surface of the tap casing (41) is smooth and built in such manner that when placed over the equally smooth surface of the pump casing (31), oil is prevented from leaking over the sides.

2.2. Lid Casing (4): (FIG. 7) the lid casing is directly attached to the pump casing; Moreover, it functions to cover the clutch control tap's entrance chamber (15). In this section are holes (45) which are screwed on to the holes of the tap casing (37). Hole (46) on the lid casing is smooth and is such that the piston (42) in it may easily move backwards and forwards without having oil leaking from its sides.

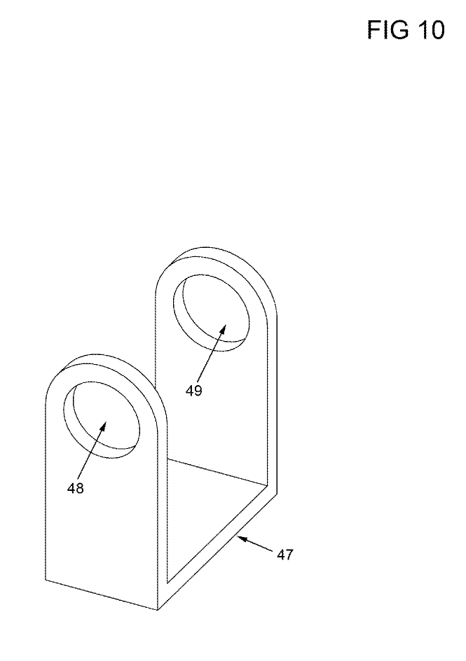

2.3. Piston (33): (FIG. 7) The Piston functions to open and close the connection between the tap entrance chamber (15) and the tap exit chamber (16) by its backward and forward motion. On the piston is a thinned section (43) which allows oil to flow from the tap entrance chamber to its exit chamber. One part of the piston's body (44) has been designed in such a way that its diameter is less than the rest of the body so that the opening and closing action of the clutch control tap would be gradual and therefore possible to control. When the tap is open (FIG. 11-A) the connection between the entrance chamber (15) and the exit chamber (16) of the tap is made possible thereby allowing oil to circulate easily within the system. It follows then that with the tap closed (FIG. 11-B), the connection between the entrance (15) and exit (16) chambers of the tap is likewise closed thus putting a halt to the circulation of oil. One surface part of the piston (42) fits into the hole on the lid casing (46) while surface part number (52) fits into number (16) on the tap casing.
3. Base of Clutch (47): (FIG. 10) The base is a structure which allows the entrance shaft (2) and the lid casing (4) to turn on the same axis through holes (48) and (49) on the base of the clutch.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents. Thus, the scope of the invention is not limited to the disclosed embodiments.

We claim:

1. A pump clutch (1) for transferring energy from an input shaft to an output shaft, wherein said pump clutch comprises: an input shaft (2); and an output shaft wherein said output shaft comprises of a hydraulic pump (5) and a control tap (17) wherein said control tap comprises of tap casing (32) and a piston (33), wherein said hydraulic pump comprises of a case (12) and a means for producing pressure (25), wherein said means for producing pressure circulates a predetermined amount of oil within said output shaft, and wherein said input shaft is connected to said means for producing pressure (25), and wherein said input shaft turns said means for producing pressure, and wherein said control tap controls said predetermined amount of oil circulating within said output shaft, and wherein said predetermined amount of circulating oil determines amount of transferring energy from said input shaft to said output shaft.

2. The pump clutch for transferring energy as claimed in claim 1, wherein said hydraulic pump case rotates in accordance to rotations of said input shaft.

3. The pump clutch (1) for transferring energy as claimed in claim 1, wherein said output shaft further comprises:
an entrance chamber (13);
an exit chamber (14);
a tap entrance chamber (15);
a tap exit chamber (16);
a first transfer tube (18), a second transfer tube (19) and a third transfer tube (36), wherein said first transfer tube (18) connects said exit chamber (14) to said tap entrance chamber (15) and wherein said second transfer tube (19) and third transfer tube (36) connect said tap entrance chamber (15) to said entrance chamber (13);
Means for opening said control tap to allow circulation of oil through said entrance chamber (13) onto said exit chamber (14);
Means for transferring energy received by said input shaft from said source of energy to said output shaft by closing said control tap to prevent circulation of said oil between said entrance chamber (13) onto said exit chamber (14).

4. The pump clutch (1) for transferring energy as claimed in claim 3, wherein said control tap (17) is situated between said entrance chamber (13) and said exit chamber (14).

5. The pump clutch (1) for transferring energy as claimed in claim 4, wherein said control tap is a part of said output shaft and rotates according to rotation of said output shaft.

6. The pump clutch (1) for transferring energy as claimed in claim 4, wherein said control tap is in a fixed position and is detached from said output shaft.

7. The pump clutch (1) for transferring energy as claimed in claim 1, wherein said output shaft is fixed to a fixed base surface and said source of energy applied to said input shaft is transferred to said fixed base surface.

8. The pump clutch (1) for transferring energy as claimed in claim 7, wherein said energy transferred to said fixed base surface is controlled by said control tap.

9. The pump clutch (1) for transferring energy as claimed in any of claims 1-8, wherein said input shaft and said output shaft are interchangeable.

10. A method for transferring energy from an input shaft to an output shaft, wherein said method comprises steps of:
Receiving a predetermined amount of energy from a source of energy by said input shaft;
Circulating a predetermined amount of a substance within said output shaft;
Obtaining a desirable amount of transferred energy from said input shaft to said output shaft by Controlling said circulating within said output shaft.

11. The method for transferring energy from an input shaft to an output shaft as claimed in claim 10, wherein said method further comprises steps of:
Producing a pressure by a hydraulic gear pump wherein said hydraulic gear pump comprises of an interior rotor (6), and a exterior rotor (7), and wherein said interior rotor and said exterior rotor are engaged in way that a predetermined space is created for said substance circulation;
Controlling said circulation by a control tap, wherein said energy received from said source of energy by said input shaft is transferred to said output shaft according to said predetermined amount of substance circulating within said output shaft, and wherein said predetermined amount of circulating substance determines amount of transferring energy from said input shaft to said output shaft.
